(19) United States
(12) Patent Application Publication
(10) Pub. No.: US 2023/0194305 A1
(43) Pub. Date: Jun. 22, 2023

(54) MAPPING FOR AUTONOMOUS VEHICLE PARKING

(71) Applicants: Eduardo Jose Ramirez Llanos, Rochester, MI (US); Julien Ip, Royal Oak, MI (US)

(72) Inventors: Eduardo Jose Ramirez Llanos, Rochester, MI (US); Julien Ip, Royal Oak, MI (US)

(21) Appl. No.: 17/645,604

(22) Filed: Dec. 22, 2021

(51) Int. Cl. G01C 21/00; G06V 20/58; G06T 7/521; H04N 5/247; G06K 9/62; B60W 40/02; B60W 60/00

(52) U.S. Cl. CPC G01C 21/3848; G06V 20/586; G06T 7/521; H04N 5/247; G06K 9/6288; B60W 40/02; G01C 21/3807; B60W 60/001; G06T 2207/30244; G06T 2207/10028; G06T 2207/30264; B60W 2420/42; B60W 2420/62; B60W 2520/28

(57) ABSTRACT

A method and system for creating a map of an environment surrounding a vehicle includes a camera for obtaining images including objects within an environment from at least one camera mounted on the vehicle and a controller configured to create a depth map of the environment based on the images and vehicle odometry information. A laser scan of the depth map is created and used to create a two-dimensional map utilized for operating the vehicle.

### TECHNICAL FIELD

The present disclosure relates to method and system for generating a map utilized for autonomous navigation of a vehicle.

### BACKGROUND

Autonomously operated or assisted vehicles utilize a map of the environment surrounding the vehicle to define a vehicle path. Information from sensor systems within the vehicle are utilized to define the map. Current vehicles produce large amounts of information from a wide array of sensor systems. Processing and obtaining useful information in an efficient manner can be challenging. Automotive suppliers and manufactures continually seek improved vehicle efficiencies and capabilities.

The background description provided herein is for the purpose of generally presenting a context of this disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A method of creating a map of an environment surrounding a vehicle according to a disclosed exemplary embodiment includes, among other possible things, the steps of obtaining images including objects within an environment from at least one camera mounted on the vehicle, creating a depth map of the environment based on the images obtained from the camera and vehicle odometry information, creating a laser scan of the depth map, and creating a two-dimensional map based on the laser scan of the depth map.

Another exemplary embodiment of the foregoing method further comprises determining a pose of the camera utilizing at least one sensor system of the vehicle and creating the depth map is based on the images form the camera and the pose of the camera.

In another exemplary embodiment of any of the foregoing methods, the at least one sensor system comprises one of at least an accelerometer, a wheel speed sensor, a wheel angle sensor, an inertial measurement unit or a global positioning system.

Another exemplary embodiment of any of the foregoing methods further comprises a dynamic model of vehicle odometry and determining a pose of the camera utilizing information from the dynamic model.

In another exemplary embodiment of any of the foregoing methods, the at least one camera mounted on the vehicle comprises at least a front camera, a first side camera and a second side camera.

In another exemplary embodiment of any of the foregoing methods, the at least one camera comprises a mono-camera.

In another exemplary embodiment of any of the foregoing methods, creating the two-dimensional map further comprises using a pose of the vehicle camera and the laser scan.

In another exemplary embodiment of any of the foregoing methods, the two-dimensional map is created with a local reference coordinate system.

Another exemplary embodiment of any of the foregoing methods further comprises creating the two-dimensional map with a controller disposed within the vehicle and saving the map within a memory device associated with the controller.

Another exemplary embodiment of any of the foregoing methods further comprises accessing instructions saved in one of the memory device or a computer readable medium that prompt the controller to create the two-dimensional map.

Another exemplary embodiment of any of the foregoing methods further comprises communicating the two-dimensional map with a vehicle control system.

An autonomous vehicle system for creating a map providing for interaction of the vehicle within an environment, the system according to another exemplary embodiment includes, among other possible things, a controller configured to obtain images including objects within an environment from at least one camera mounted on the vehicle, create a depth map of the environment based on images obtained from the camera and vehicle odometry information, create a laser scan of the depth map, and create a two-dimensional map based on the laser scan of the depth map.

In another exemplary embodiment of any of the foregoing autonomous vehicle systems, the controller is further configured to determine a pose of the camera utilizing at least one sensor system of the vehicle and creating the depth map is based on the images form the camera and the pose of the camera.

In another exemplary embodiment of any of the foregoing autonomous vehicle systems, the controller is further configured to utilize the pose for the creation of the two-dimensional map.

In another exemplary embodiment of any of the foregoing autonomous vehicle systems, the at least one sensor system of the vehicle comprises at least one an accelerometer, a wheel speed sensor, a wheel angle sensor, an inertial measurement unit or a global positioning system.

In another exemplary embodiment of any of the foregoing autonomous vehicle systems, the at least one camera mounted on the vehicle comprises at least a front camera, a first side camera and a second side camera.

In another exemplary embodiment of any of the foregoing autonomous vehicle systems, the at least one camera mounted on the vehicle comprises a mono-camera.

Another exemplary embodiment of any of the foregoing autonomous vehicle systems further comprises a vehicle control system that utilizes the two-dimensional map to define interaction of the vehicle with the surrounding environment represented by the two-dimensional map.

A computer readable medium comprising instructions executable by a controller for creating a map of an environment surrounding a vehicle, the instructions according to another exemplary embodiment includes, among other possible things, instructions prompting a controller to obtain images including objects within an environment from at least one camera mounted on the vehicle, instructions prompting the controller to create a depth map of the environment based on images obtained from the camera and vehicle odometry information, instructions prompting the controller to create a laser scan of the depth map, and instructions prompting the controller to create a two-dimensional map based on the laser scan of the depth map and a pose of the vehicle camera.

Another exemplary embodiment of the foregoing The computer readable medium further comprises instructions for determining the pose of the camera utilizing at least one sensor system of the vehicle and creating the depth map is based on the images form the camera and the pose of the camera.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example embodiment of a system disposed within a vehicle for mapping an environment around the vehicle.

FIG. 2 is a flow diagram of an embodiment of a method of generating a map to aid in the parking of an autonomous vehicle.

FIG. 3 is an example image from a vehicle mounted camera.

FIG. 4 is an example depth map generated from an example image taken from a camera disposed within a vehicle.

FIG. 5 is a point cloud laser scan generated from information provided from the depth map and vehicle odometry.

FIG. 6 is a two-dimensional map that is utilized by a vehicle navigation system to aid an autonomous vehicle in parking.

### DETAILED DESCRIPTION

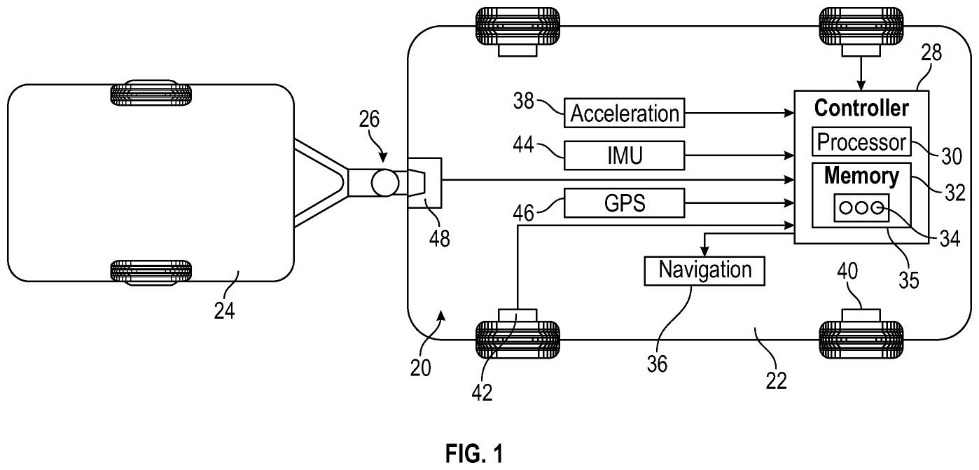

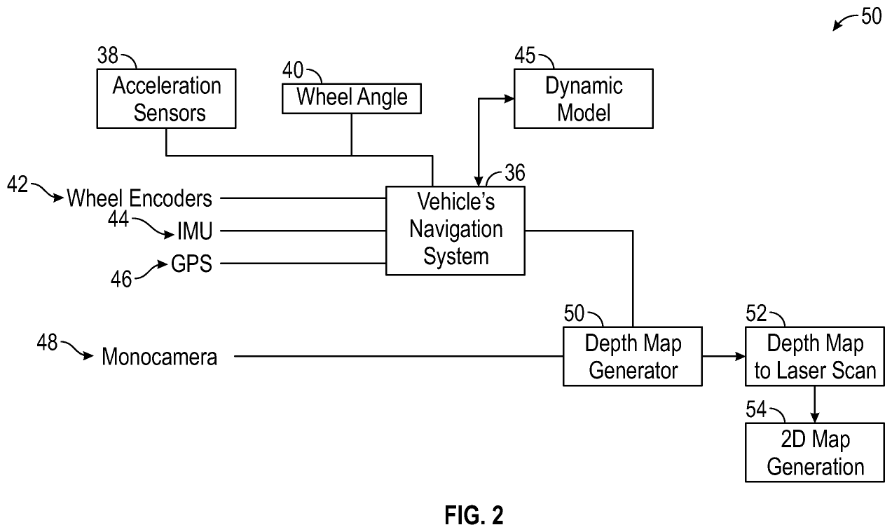

Referring to FIGS. 1 and 2, a vehicle 22 is schematically illustrated and includes a vehicle control system 20 for generating a map utilized for autonomous and/or semi-autonomous operation of the vehicle 22. In one disclosed embodiment, the system 20 provides for the identification of open spaces within a parking lot. In one disclosed embodiment, the system 20 generates a two-dimensional map that is utilized along with data indicative of vehicle operation to define and locate empty spaces that are suitable for parking of the vehicle 22.

In a disclosed example embodiment, the system 20 constructs a real-time two-dimensional map of objects including other vehicles and objects for use in autonomous and/or semi-autonomous operation of a vehicle. Autonomous operation may include operation with or without an operator within the vehicle. Semi-autonomous operation includes operation in the presence of a vehicle operator.

The example vehicle 22 includes a controller 28 with a processor 30, and a memory device 32 that includes software 34. The software 34 may also be stored on a computer readable storage medium schematically indicated at 35.

The example controller 28 may be a separate controller dedicated to the control system 20 are may be part of an overall vehicle controller. Accordingly, example controller 28 relates to a device and system for performing necessary computing and/or calculation operations of the control system 20. The controller 28 may be specially constructed for operation of the control system 20, or it may comprise at least a general-purpose computer selectively activated or reconfigured by software instructions 34 stored in the memory device 32. The computing system can also consist of a network of (different) processors.

The instructions 34 for configuring and operating the controller 28, the control system 20 and the processor 30 are embodied in the software instructions 34 that may be stored on a computer readable medium 35. The computer readable medium 35 may be embodied in structures such as, but is not limited to, any type of disk including floppy disks, optical disks, CD-ROMs, magnetic-optical disks, read-only memories (ROMs), random access memories (RAMS), EPROMs, EEPROMs. magnetic or optical cards, application specific integrated circuits (ASICs), or any type of media suitable for storing electronic instructions, and each coupled to a computer system bus. The disclosed computer readable medium may be a non-transitory medium such as those examples provided.

Moreover, the software instructions 34 may be saved in the memory device 32. The disclosed memory device 32, may can include any one or combination of volatile memory elements (e.g., random access memory (RAM, such as DRAM, SRAM, SDRAM, VRAM, etc.) and/or nonvolatile memory elements (e.g., ROM, hard drive, tape, CD-ROM, etc.). The software instructions 34 in the memory device 32 may include one or more separate programs, each of which includes an ordered listing of executable instructions for implementing logical functions. The disclosed controller 28 is configured to execute the software instructions 34 stored within the memory device 32, to communicate data to and from the memory device 32, and to generally control operations pursuant to the software. Software in memory, in whole or in part, is read by the processor 30, perhaps buffered within the processor, and then executed.

The vehicle 20 includes sensors and sensor systems that provide information indicative of vehicle operation referred to as vehicle odometry. In the disclosed example embodiment, the vehicle 22 includes wheel angle sensors 40, wheel speed sensors 42, an acceleration sensor 38, an inertial measurement unit 44, and a global positioning sensor 46. It should be appreciated, that although several sensor systems are described by way of example, other sensor systems may also be utilized within the scope and contemplation of this disclosure. The example vehicle 22 also includes a camera system 48 that captures images of objects and the environment around the vehicle 22.

In the disclosed example embodiment, the vehicle 22 is coupled to a trailer 24 by way of a coupling 26. The disclosed system 20 provides an output that is utilized by the vehicle control system 20 for defining and operating the vehicle 22 and trailer.

The example system 20 defines a two-dimensional map utilizing information from the camera system 48 along with vehicle odometry provided by sensors 38, 40, 42, 44 and 46. The steps taken and performed by the controller 28 are schematically shown in flow chart 55. The flow chart 55 illustrates how information from the sensors 38, 40, 42, 44 and 46 are provided to the vehicle navigation system 36. The navigation system 36 compiles this information to provide information indicative of operation of the vehicle and the general orientation and movement of the vehicle 22. The information that is accumulated in the vehicle navigation system 36 is combined with images from the camera 48 along with a known pose of the camera in a depth map generator 50.

The information provided by the sensor systems 38, 40, 42, 44 and 46 to the navigation system 36 may be utilized to generate a vehicle dynamic model 45. The vehicle dynamic model 45 provides information indicative of vehicle movement. The dynamic model 45 may be a separate algorithm executed by the controller 28 according to software instructions 34 saved in the memory device 32.

The controller 28 includes the depth map generator 50 and instructions for producing the laser scan 52 and a two-dimensional map 54. The depth map generator 50, the laser scan 52 and the two-dimensional map 54 are embodied in the controller 28 as software instructions that are performed by the processor 30. Each of these features may be embodied as algorithms or separate software programs accessed and performed by the processor 30. Moreover, the specific features and operation of the depth map generator 50, the laser scan 52 and the two-dimensional map 54 may include one of many different operations and programs as are understood and utilized by those skilled in the art.

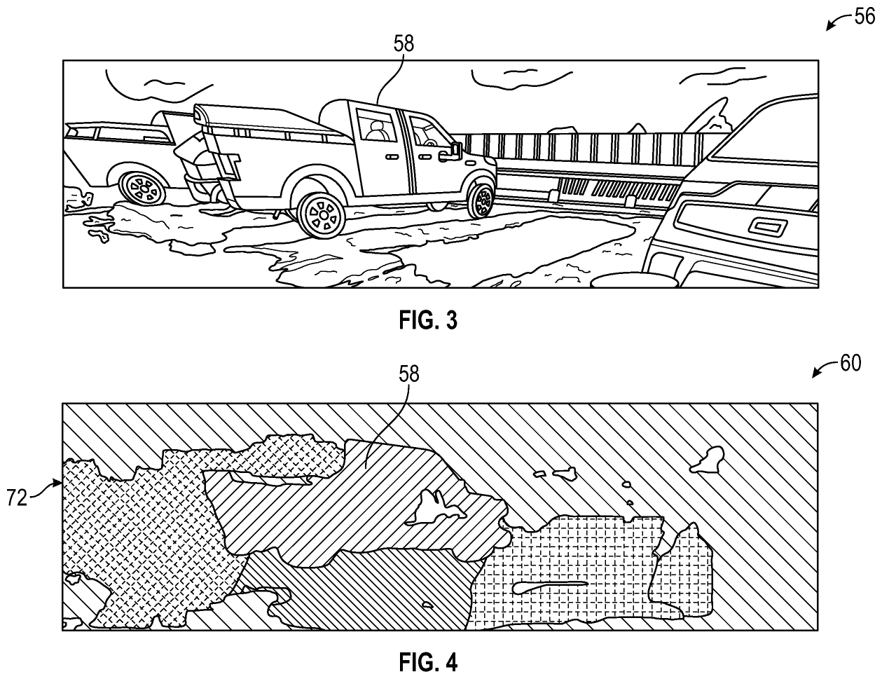

Referring to FIGS. 3 and 4, with continued reference to FIG. 2, the example depth map generator 50 takes an image indicated at 56 that includes various objects 58 and creates a depth map 60. The depth map 60 is an image that includes different gray scales that are all indicative of a distance between the vehicle 22 and the object 58.

The distance between the vehicle is actually a distance between the camera 48 and any of the objects 58. Knowledge of the position of the camera 48 within the vehicle 22 is utilized to determine a pose of the camera and an actual distance between the vehicle 22 and any of the surrounding objects. The depth map 60 portrays an object such as the parked car indicated at 58 as a series of differently colored points that are each indicative of a distance between the vehicle 22 and the object 58. As is shown in the depth map 60, the vehicle 58 is identified and substantially the same colors as the distance between any one point of the object 58 is negligible. Moreover, the depth map 60 includes several dark to black point cloud portions that are indicative of objects that are in excessive distance from the vehicle 22. Such objects include the background and other things that are within the image but are too far to be of significant use.

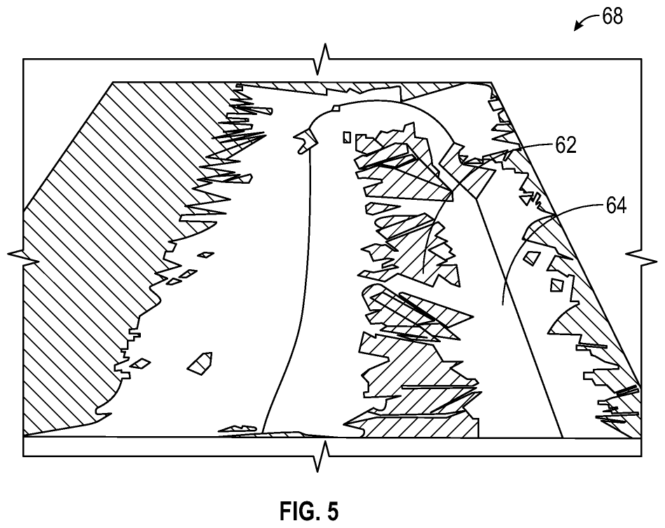

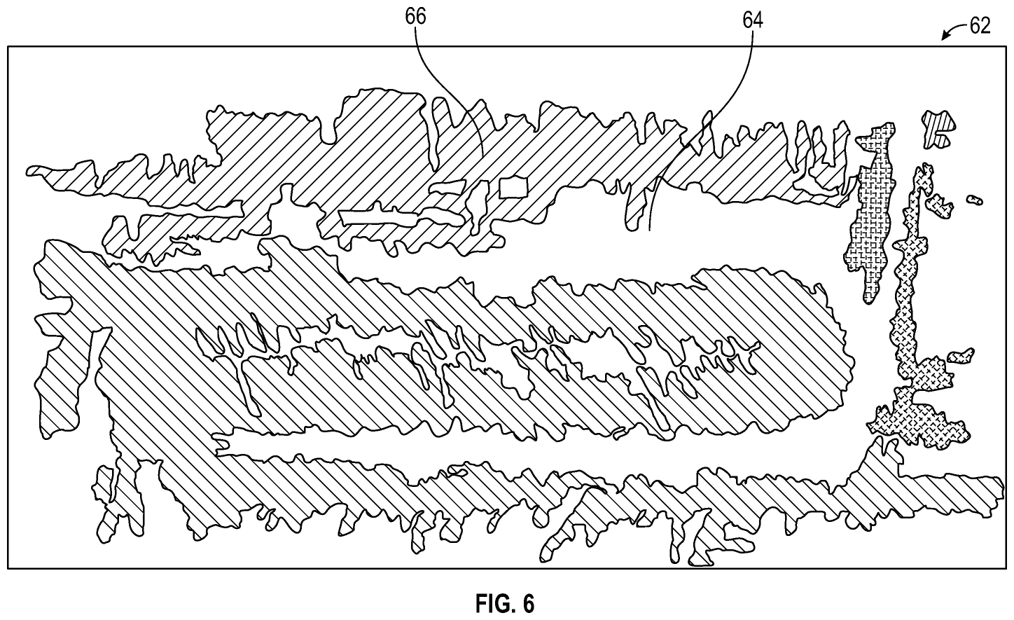

Referring to FIG. 5, with continued reference to FIGS. 1 and 2, the depth map 60 is converted into a laser scan as is indicated at 52 in flow chart 55. The example laser scan is a simplification of the three-dimensional depth map 60. The two-dimensional laser scan 68 includes shading that is indicative of objects 66 and of empty space 64. The amount of processing requirements to compute a real-time usable map are less burdensome with the laser scan map 68 as compared to the depth map 60.

Referring to FIG. 6, with continued reference to FIG. 2, the laser scan 52 is then converted into a two-dimensional map as is illustrated in FIG. 6 and indicated at 62. This two-dimensional map 62 includes the open spaces 64 and indications of objects 66 that correspond with those in the laser scan 68 and the depth map 60. The two-dimensional map 62 is continually updated to provide information that is utilized by the autonomous vehicle for operation.

The two-dimensional map 62 utilizes information from both the laser scan 68 and also from the vehicle navigation system 36 that is indicative of vehicle operation. Moreover, the vehicle navigation system 36 provides information for the determination of a pose of the camera 48. The pose of the camera 48 is a term that is utilized to describe the perspective of the camera 48 relative of the vehicle 22 and the surrounding environment. It should be appreciated that although one camera 48 is illustrated by example, many cameras 48 disposed about the vehicle 22 may be utilized and are within the contemplation of this disclosure. Moreover, in one disclosed example, the camera 48 is a mono-camera, however other camera configurations may also be utilized within the scope and contemplation of this disclosure.

The two-dimensional map 62 as shown in FIG. 6 is an illustrative example of a parking lot where objects 66 are indicative of vehicles parked and the empty space 64 is indicative of the roadway or spacing between the parked vehicles. The two-dimensional map 62 is created within a local reference coordinate system.

The maps referred to in this example disclosure are not necessarily generated for viewing by a vehicle operator. Instead, each of the disclosed maps are generated for use by the control system 20 to provide for navigation of a vehicle through an environment autonomously and/or semi-autonomously. The maps are therefore generated to provide a means of organizing data associated with locations within an environment surrounding the vehicle 22. Moreover, each of the maps described in this disclosure describe an organization of information and relationships between the organized information indicative of the environment surrounding the vehicle. The two-dimensional map 62 may be saved in the memory device 32 and/or on the computer readable medium 35 to enable access by the processor 30.

The example control system utilizes the generated two-dimensional map 62 to provide and generate navigation instructions to operate the vehicle 22 within the environment illustrated and provided by the two-dimensional map 62.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A method of creating a map of an environment surrounding a vehicle comprising the steps of:
obtaining images including objects within an environment from at least one camera mounted on the vehicle;
creating a depth map of the environment based on images obtained from the camera and vehicle odometry information;
creating a laser scan of the depth map; and
creating a two-dimensional map based on the laser scan of the depth map.

2. The method as recited in claim 1, further comprising determining a pose of the camera utilizing at least one sensor system of the vehicle and creating the depth map is based on the images form the camera and the pose of the camera.

3. The method as recited in claim 2, wherein the at least one sensor system comprises one of at least an accelerometer, a wheel speed sensor, a wheel angle sensor, an inertial measurement unit or a global positioning system.

4. The method as recited in claim 1, further comprising a dynamic model of vehicle odometry and determining a pose of the camera utilizing information from the dynamic model.

5. The method as recited in claim 1, wherein the at least one camera mounted on the vehicle comprises at least a front camera, a first side camera and a second side camera.

6. The method as recited in claim 1, wherein the at least one camera comprises a mono-camera.

7. The method as recited in claim 1, wherein creating the two-dimensional map further comprises using a pose of the vehicle camera and the laser scan.

8. The method as recited in claim 1, wherein the two-dimensional map is created with a local reference coordinate system.

9. The method as recited in claim 1, further comprising creating the two-dimensional map with a controller disposed within the vehicle and saving the map within a memory device associated with the controller.

10. The method as recited in claim 9, further comprising accessing instructions saved in one of the memory device or a computer readable medium that prompt the controller to create the two-dimensional map.

11. The method as recited in claim 1, further comprising communicating the two-dimensional map with a vehicle control system.

12. An autonomous vehicle system for creating a map providing for interaction of the vehicle within an environment, the system comprising:
a controller configured to:
obtain images including objects within an environment from at least one camera mounted on the vehicle;
create a depth map of the environment based on images obtained from the camera and vehicle odometry information;
create a laser scan of the depth map; and
create a two-dimensional map based on the laser scan of the depth map.

13. The autonomous vehicle system as recited in claim 12, wherein the controller is further configured to determine a pose of the camera utilizing at least one sensor system of the vehicle and creating the depth map is based on the images form the camera and the pose of the camera.

14. The autonomous vehicle system as recited in claim 13, wherein the controller is further configured to utilize the pose for the creation of the two-dimensional map.

15. The autonomous vehicle system as recited in claim 14, wherein the at least one sensor system of the vehicle comprises at least one an accelerometer, a wheel speed sensor, a wheel angle sensor, an inertial measurement unit or a global positioning system.

16. The autonomous vehicle system as recited in claim 14, wherein the at least one camera mounted on the vehicle comprises at least a front camera, a first side camera and a second side camera.

17. The autonomous vehicle system as recited in claim 12, wherein the at least one camera mounted on the vehicle comprises a mono-camera.

18. The autonomous vehicle system as recited in claim 17, further comprising a vehicle control system that utilizes the two-dimensional map to define interaction of the vehicle with the surrounding environment represented by the two-dimensional map.

19. A computer readable medium comprising instructions executable by a controller for creating a map of an environment surrounding a vehicle, the instructions comprising:
instructions prompting a controller to obtain images including objects within an environment from at least one camera mounted on the vehicle;
instructions prompting the controller to create a depth map of the environment based on images obtained from the camera and vehicle odometry information;
instructions prompting the controller to create a laser scan of the depth map; and
instructions prompting the controller to create a two-dimensional map based on the laser scan of the depth map and a pose of the vehicle camera.

20. The computer readable medium as recited in claim 19, further comprising instructions for determining the pose of the camera utilizing at least one sensor system of the vehicle and creating the depth map is based on the images form the camera and the pose of the camera.
